(19) United States
(12) Patent Application Publication
(10) Pub. No.: US 2006/0016651 A1
(43) Pub. Date: Jan. 26, 2006

(54) Shock absorber of a seat of a wheelchair

(76) Inventor: Samuel Lin, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/894,000

(22) Filed: Jul. 20, 2004

(51) Int. Cl. F16M 1/00

(52) U.S. Cl. 188/322.22; 188/322.19; 267/136

(57) ABSTRACT

A shock absorber is provided to a seat of a wheelchair, which includes an outer tube secured on an upper side of a frame of the wheelchair, an inner tube secured on a bottom of the seat and movably passed into the outer tube, and a spring-loaded shock absorbing mechanism; the outer tube is formed with a pair of opposing radial through holes on an upper end portion thereof; the inner tube is formed with two opposing lengthwise extending slots, and is prevented from separating from the outer tube with help of a pin, which is passed through the radial holes as well as the slots; the shock absorbing mechanism is held in the outer tube and connected to the outer tube, and a lower end of the inner tube at lower and upper ends respectively.

### BACKGROUND OF THE INVENON

1. Field of the Invention

The present invention relates to a shock absorber of a seat of a wheelchair, which can reduce violent shaking of the seat effectively for the wheelchair to be comfortable to ride on.

2. Brief Description of the Prior Art

Conventional wheelchairs for people to ride on are usually only equipped with shock absorbers between the wheels and the frame, but are not equipped with shock absorbers for the seats. Therefore, violent shaking of one such conventional wheelchair can't be effectively reduced, and a person ridding on the wheelchair will still feel uncomfortable when the wheelchair is shaking violently.

### SUMMARY OF THE INVENTION

It is a main object of the present invention to provide a shock absorber of a seat of a wheelchair such that violent shaking of the seat can be effectively reduced.

The shock absorber of the present invention includes an outer tube secured on an upper side of a frame of the wheelchair, an inner tube secured on a bottom of the seat and movably passed into the outer tube, and a spring-loaded shock absorbing mechanism. The outer tube is formed with a pair of opposing radial holes on an upper end portion. The inner tube is formed with two opposing lengthwise extending slots, and is prevented from separating from the outer tube with help of a pin, which is passed through the radial holes as well as the slots; the shock absorbing mechanism is held in the outer tube and connected to the outer tube, and a lower end of the inner tube at lower and upper ends thereof respectively.

### BRIEF DESCRIPTION OF THE DRAWINGS

The present invention will be better understood by referring to the accompanying drawings, wherein:

FIG. 1 is a perspective view of the wheelchair according to the present invention,

FIG. 2 is an exploded perspective view of the shock absorber of the present invention,

FIG. 3 is a vertical section of the shock absorber according to the present invention,

FIG. 4 is a vertical section of the shock absorber of the present invention functioning,

FIG. 5 is another vertical section of the shock absorber of the present invention functioning,

FIG. 6 is an exploded perspective view of the second embodiment of a shock absorber in the present invention,

FIG. 7 is a vertical section of the second embodiment, and

FIG. 8 is a vertical section of the second embodiment functioning.

### DETAILED DESCRIPTION OF THE PREFERRED EMBODIMENTS

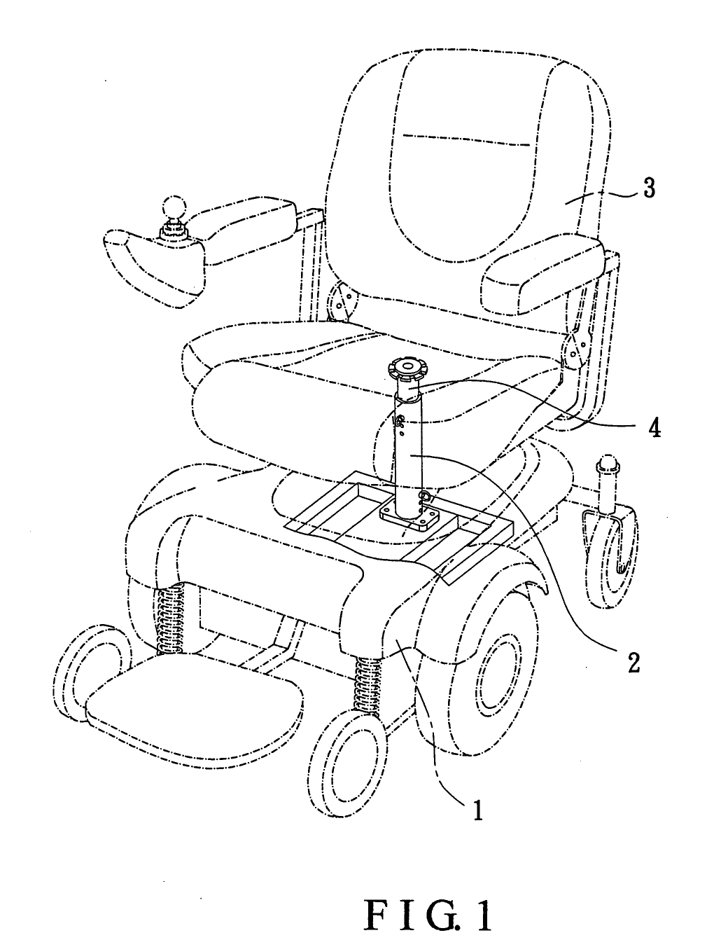

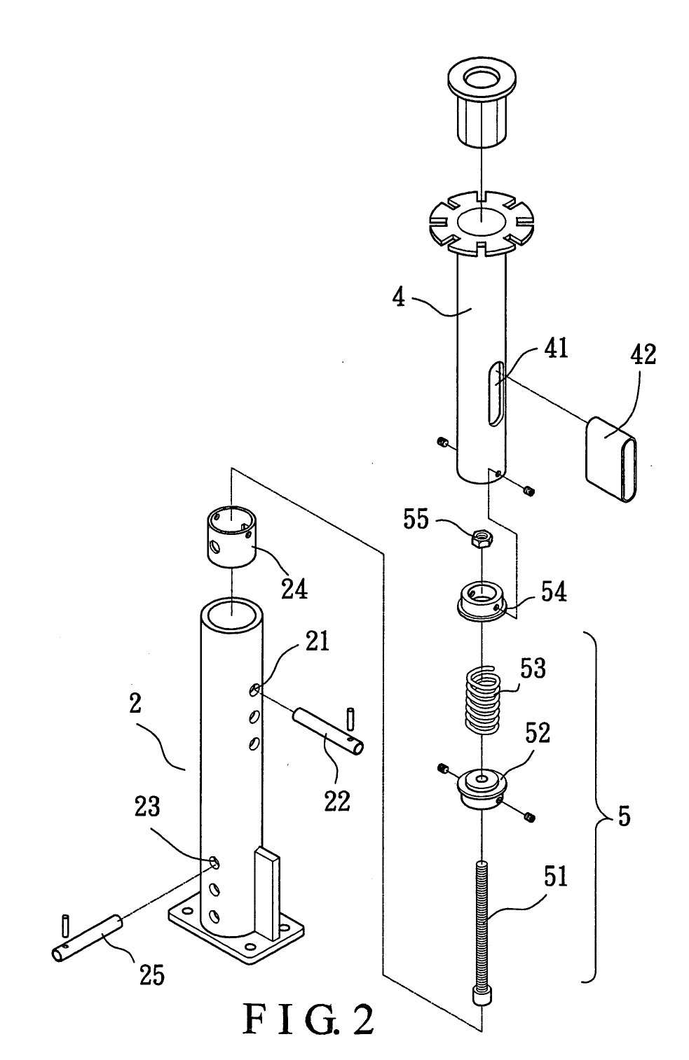

Referring to FIGS. 1 and 2, a preferred embodiment of a shock absorber of a seat 3 of a wheelchair includes an outer tube 2, a shock absorbing mechanism 5, and an inner tube 4.

The outer tube 2 is secured on an upper side of a frame 1 of the wheelchair at a lower end, and upright, and is formed with several pairs of opposing radial through holes 21 along an upper end portion, and several pairs of opposing radial through holes 23 along a lower end portion thereof; the number of the upper radial through holes 21 are the same as that of the lower radial through holes 23, and the distance between every two adjacent upper holes 21 is the same as the distance between every two adjacent lower holes 23. A locating element 24 is disposed in the lower portion of the outer tube 2, and is secured in position by means of a securing pin 25, which is tightly passed through a selected pair of lower through holes 23 as well as the locating element 24.

The inner tube 4 is secured on a bottom of the seat 3 at an upper end thereof, and upright, and is formed with two lengthwise extending slots 41, which are right faced with each other, and are near to a lower end of the inner tube 4. A strengthening element 42, which has a through hole similar to the slots 41 in shape, is tightly fitted in the slots 41. The inner tube 4 is up and down movably passed into the outer tube 2, and a pin 22 is passed through a selected pair of upper through holes 21 as well as the strengthening element 42 to prevent the inner tube 4 from separating from the outer tube 2; thus, the inner tube 4 can only be displaced relative to the outer tube 2 within a certain range.

The shock absorbing mechanism 5 is disposed between the locating element 24 of the outer tube 2 and the lower end of the inner tube 4, and includes a bolt 51, a lower cap 52, an elastic element 53, an upper cap 54, and a nut 55; the lower cap 52 is securely connected to the locating element 24, the elastic element 53 is positioned right above the lower cap 52, and the upper cap 54 is positioned right above the elastic element 53 while the bolt 51 is first passed through the lower cap 52, the elastic element. 53, and the upper cap 54 in sequence, and then screwed into the nut 55. In addition, the upper cap 54 is securely connected to the lower end of the inner tube 4. Thus, violent shaking of the seat 3 will be reduced owing to the shock absorber, and the wheelchair more comfortable to ride on.

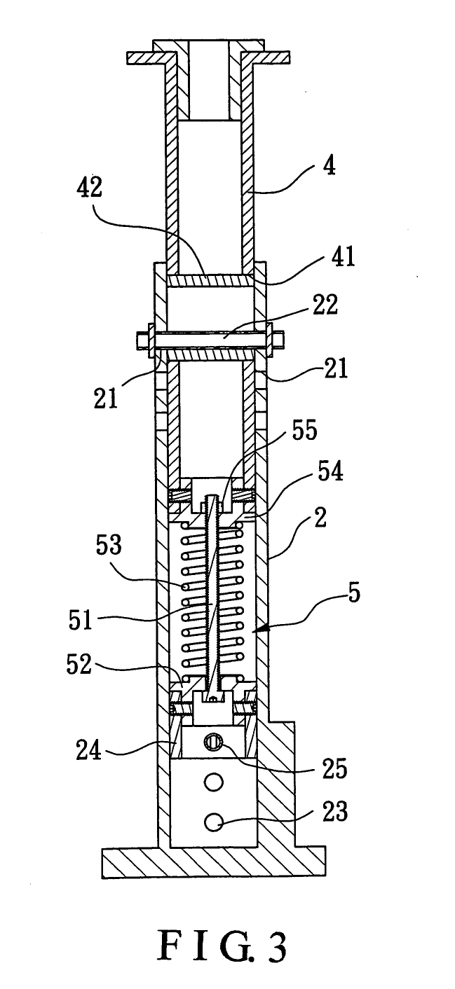

In assembling the wheelchair of the present invention, referring to FIG. 3, first the lower cap 52 of the shock absorbing mechanism 5 is joined to the locating element 24, and the upper cap 54 is joined to the lower end of the inner tube 4. Next, the shock absorbing mechanism 5 and the inner tube 4 are passed into the outer tube 2, and the locating element 24 is secured in the lower end of the outer tube 2, and the pin 22 is passed through a selected pair of upper radial through holes 21 as well as the strengthening element 42.

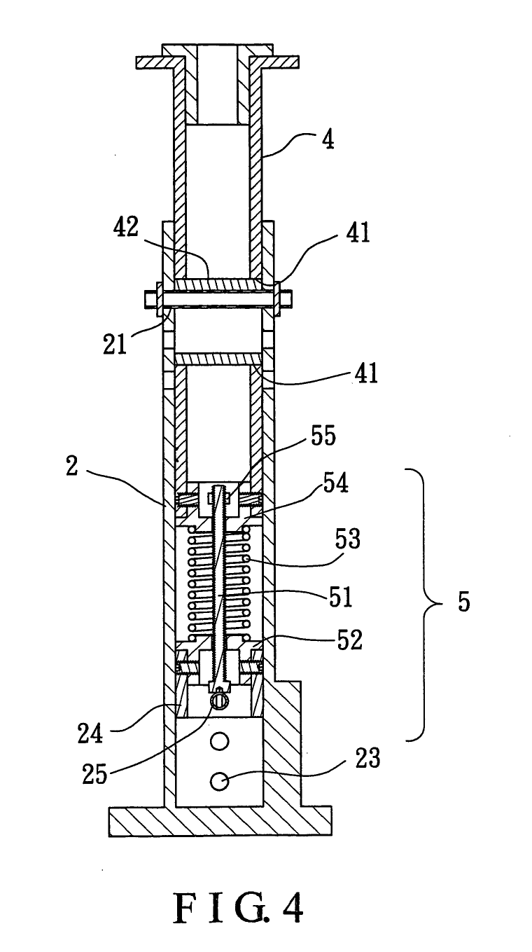

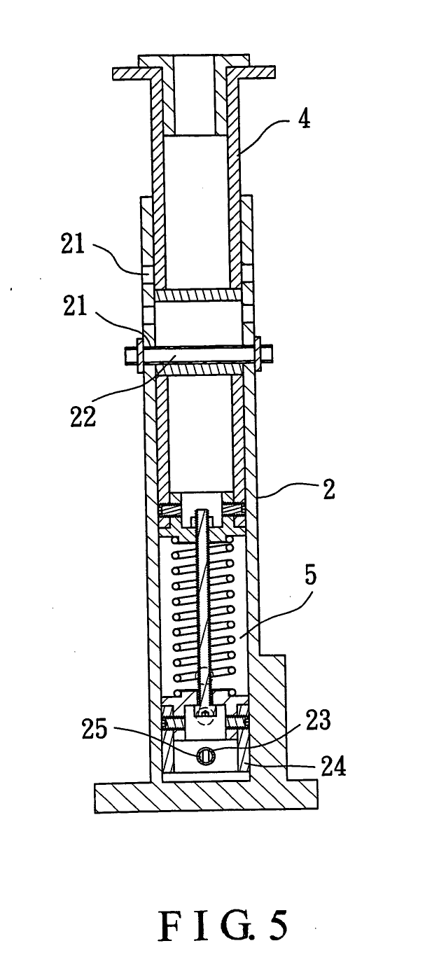

Referring to FIGS. 4 and 5, when a person is ridding on the wheelchair, and the seat 3 is caused to move up and down owing to uneven surface of the ground, the elastic element 53 will change shape accordingly, and reduce violent shaking of the seat 3.

To adjust the height of the seat 3, one should first remove the pins 22 and 25 from the original through holes 21, 23 of the outer tube 2, and then pass the pin 22 through another pair of upper radial through holes 21, e.g. the uppermost pair, as well as the strengthening element 42, and also pass the locating pin 25 through another pair of lower radial through holes 23 accordingly, i.e. the uppermost pair, as well as the locating element 24.

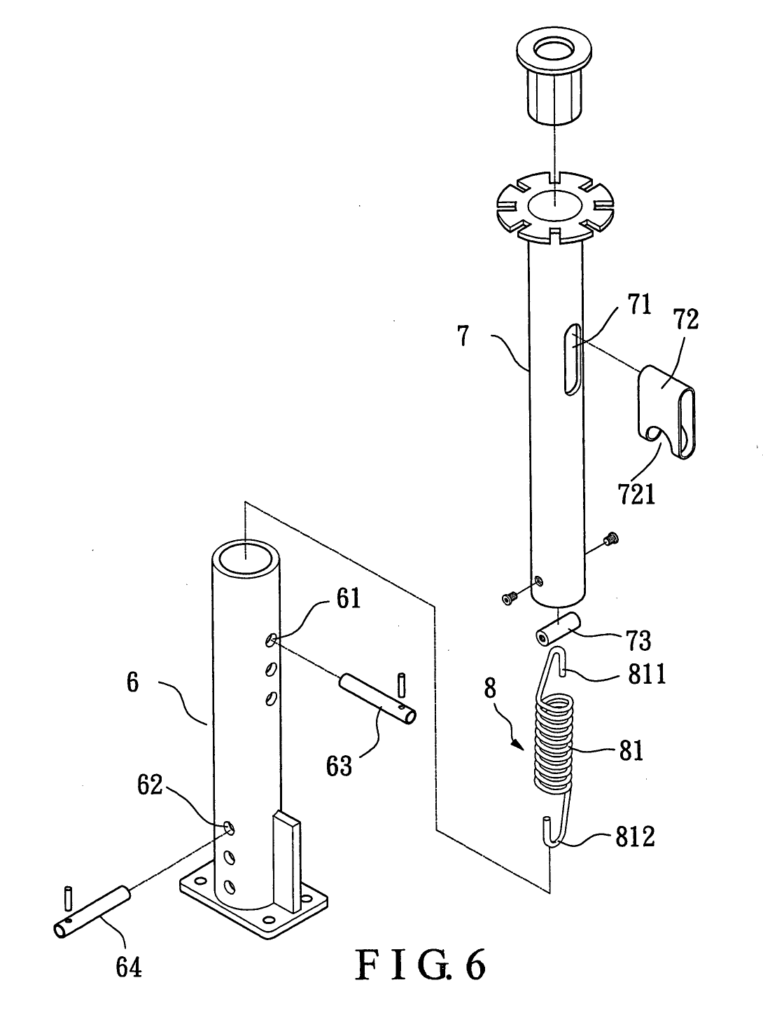

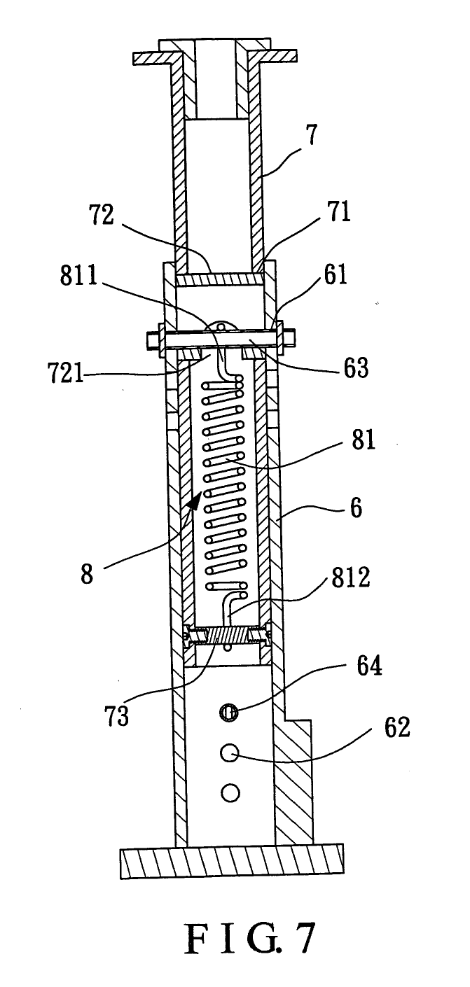

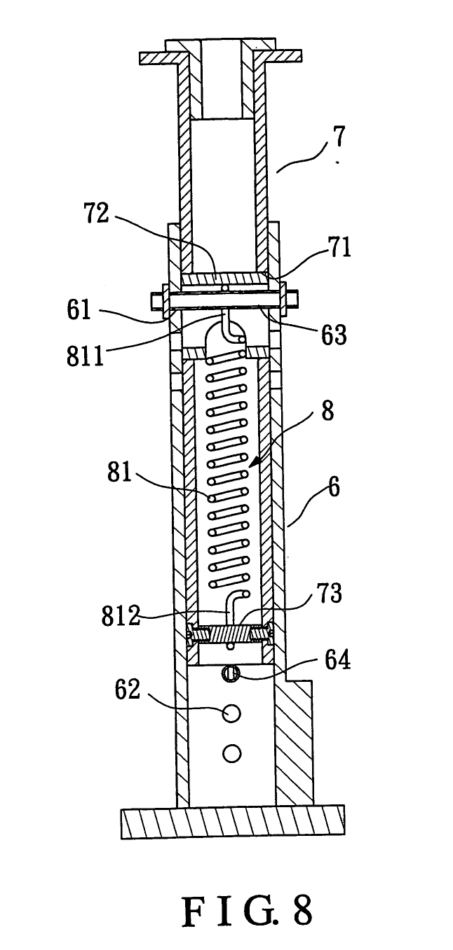

Referring to FIGS. 6 to 8, a second embodiment of a shock absorber of a wheelchair includes an outer tube 6, a shock absorbing mechanism 8, and an inner tube 7.

The outer tube 6 is formed with several pairs of opposing radial through holes 61 along an upper end portion, and several pairs of opposing radial through holes 62 along a lower end portion thereof; the distance between every two adjacent upper holes 61 is the same as the distance between every two adjacent lower holes 62. A pin 64 is tightly passed through a selected pair of lower through holes 62.

The inner tube 7 is formed with two lengthwise extending slots 71, which are right faced with each other. A strengthening element 72 is tightly fitted in the slots 71, which has a through hole having the same shape as the slots 71, and a gap 721 at a bottom side thereof. The inner tube 7 is up and down movably passed into the outer tube 6, and a pin 63 is passed through the through hole of the strengthening element 72 and a selected pair of upper through holes 61; thus, the inner tube 7 can't separate from the outer tube 6, and it can only be displaced relative to the outer tube 6 within a certain range. And, the pin 64 at the lower portion of the outer tube 6 will stop the inner tube 7 to prevent the same from moving further down.

The shock absorbing mechanism 8 includes an elastic element 81, which is passed through the gap 721 of the strengthening element 72, and hooked over the pin 63 at a first end 811 thereof In addition, a locating pin 73 is secured on a lower end of the inner tube 7, and the elastic element 81 is hooked over the locating pin 73 at a second end 812 thereof.

Thus, when the seat of the wheelchair moves upwards during up and down shaking of the wheelchair, the elastic element 81 will be forced to stretch, and shaking of the seat will be reduced. Consequently, the wheelchair will be more comfortable to ride on.

From the above description, it can be easily understood that the shock absorber of the present invention can reduce violent shaking of the seat effectively while one is ridding on the wheelchair.

What is claimed is:

1. A shock absorber of a seat of a wheelchair, comprising
an outer tube secured on an upper side of a frame of a wheelchair at a lower end thereof; the outer tube being formed with a first pair of opposing radial through holes on an upper end portion thereof;
an inner tube secured on a bottom of a seat of the wheelchair at an upper end thereof; the inner tube being formed with two lengthwise extending slots faced with each other; the inner tube being movably passed into the outer tube; the inner tube being prevented from separating from the outer tube with help of a first pin, which is passed through the opposing radial through holes as well as the slots; and
a shock absorbing mechanism held in the outer tube and connected to the outer tube and a lower end of the inner tube at lower and upper ends thereof respectively for reducing shaking of the seat.

2. The shock absorber as claimed in claim 1, wherein a strengthening element, which has a through hole similar to the slots of the inner tube in shape, is tightly fitted in the slots for allowing the first pin to pass through.

3. The shock absorber as claimed in claim 2, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.

4. The shock absorber as claimed in claim 2, wherein the outer tube is formed with a first pair of opposing radial through holes on a lower end portion thereof, and has a locating element disposed therein; the locating element being secured in position by means of a second pin, which is passed through the pair of opposing radial through holes of the outer tube lower end portion, and is connected to the locating element; the lower end of the shock absorbing mechanism being connected to the locating element.

5. The shock absorber as claimed in claim 4, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.

6. The shock absorber as claimed in claim 1, wherein the outer tube is formed with a first pair of opposing radial through holes on a lower end portion thereof, and has a locating element disposed therein; the locating element being secured in position by means of a second pin, which is passed through the pair of opposing radial through holes of the outer tube lower end portion, and is connected to the locating element; the lower end of the shock absorbing mechanism being connected to the locating element.

7. The shock absorber as claimed in claim 6, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.

8. The shock absorber as claimed in claim 1, wherein the outer tube is formed with a plurality of pairs of equidistantly spaced opposing radial through holes along the upper end portion thereof in addition to the first pair for allowing the first pin to be connected thereto, and a plurality of pairs of opposing radial through holes along a lower end portion thereof for a second pin to be connected thereto; number of the upper radial through holes being same as that of the lower radial through holes; the lower through holes being as equidistantly spaced as the upper through holes; the shock absorbing mechanism being connected to the second pin at the lower end thereof, thus allowing the seat to be adjusted in height by means of relocating the first and the second pins.

9. The shock absorber as claimed in claim 8, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.

10. The shock absorber as claimed in claim 8, wherein the outer tube has a locating element disposed therein, which is secured in position by means of the second pin, and which is connected to the lower end of the shock absorbing mechanism.

11. The shock absorber as claimed in claim 10, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element and joined to the nut.

12. The shock absorber as claimed in claim 8, wherein a strengthening element, which has a through hole similar to the slots of the inner tube in shape, is tightly fitted in the slots for allowing the first pin to pass through.

13. The shock absorber as claimed in claim 12, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.

14. The shock absorber as claimed in claim 12, wherein the outer tube has a locating element disposed therein, which is secured in position by means of the second pin, and which is connected to the lower end of the shock absorbing mechanism.

15. The shock absorber as claimed in claim 14, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.

16. The shock absorber as claimed in claim 1, wherein the shock absorbing mechanism includes:
a lower cap connected to the outer tube;
an elastic element arranged on the lower cap;
an upper cap arranged on an upper end of the elastic element and connected to the lower end of the inner tube;
a nut arranged on the upper cap; and
a bolt passed through the caps as well as the elastic element, and joined to the nut.
